(19) United States
(12) Patent Application Publication
(10) Pub. No.: US 2021/0394548 A1
(43) Pub. Date: Dec. 23, 2021

(54) LOW COST COUNTER COUNTERFEIT TECHNOLOGY

(71) Applicant: Raytheon Company, Waltham, MA (US)

(72) Inventors: Gerald P. Uyeno, Tucson, AZ (US); Vanessa Reyna, Tucson, AZ (US)

(21) Appl. No.: 16/905,952

(22) Filed: Jun. 19, 2020

(51) Int. Cl. B42D 25/373; B42D 25/445; B42D 25/23; B82Y 40/00; B42D 25/324

(52) U.S. Cl. CPC B42D 25/373; B42D 25/445; B42D 25/324; B82Y 40/00; B42D 25/23

(57) ABSTRACT

An identification patch having a pattern of plasmonic resonance elements may be used to ensure that an article is counterfeit-proof. The identification patch is formed by laser-induced superplasticity to create a distinctive pattern of resonance elements that each contain a plurality of nanostructures. When the identification patch is irradiated, the pattern of resonance elements produces a unique spectral response that is associated only with the counterfeit-proof article. The counterfeit-proof article may be a metal component or an integrated circuit. The resonant absorption of the plasmonic resonance elements may be measured to verify the authenticity of the article before use of the article.

### FIELD OF THE INVENTION

The invention relates to a method and system for authenticating articles and for detecting counterfeit articles by way of a small piece of material attached to the article and a scanning diagnostic laser source and imaging spectrometer.

### DESCRIPTION OF THE RELATED ART

Various applications require verifying the authenticity of an article, such as a component or part, prior to use of the article. Particularly for safety and security purposes, authenticating the article ensures that the proper article is being provided for use in a particular application. For example, a computer processor is a component that may require authentication before use in a defense application. Using an improper or counterfeit article may result in failure of the article when used that can lead to degraded system performance or system failure.

Due to technology advances, the manufacturing of counterfeit articles has become easier and therefore more prevalent. Conventionally-used identifiers, such as silk-screen serial numbers and barcodes, may be easy to copy or replicate.

### SUMMARY OF THE INVENTION

An identification patch of material having distinctive optical properties may be used to ensure that an article is counterfeit-proof. According to a general embodiment, the identification patch has a nanometer scale structure with a well-defined pattern of resonance elements of conducting material formed by a laser-induced superplasticity process. When subject to diagnostic light of the appropriate wavelength, each resonance element in the patch has a distinctive optical response associated with the plasmonic resonance, such as a specific absorption spectrum. When the identification patch is formed and attached to the article, desired optical properties, such as the specific absorption spectrum of each element, are measured and specific data pertaining to the properties is stored in a database. The article is then transported or stored for later use. The article may be a metal component or an integrated circuit or use in a particular application. Before use of the article, each resonance element of the patch is irradiated with diagnostic light of the appropriate wavelength and the desired optical properties, such as the specific absorption spectrum, are measured. The data stored in the database is accessed to verify that the measured data matches the stored data and that the article is authentic.

The laser-induced superplasticity process is used to form a pattern, such as an array, of resonance elements. Each resonance element contains a sub-pattern or array of nanostructures. During the laser-induced superplasticity process, a forming laser is scanned across a metallic film that has an ablative material coating and is arranged on a preformed mold that contains a pattern of nanomolds that may correspond to the formed nanostructures. The forming laser pulse induces superplastic deformation using shock waves from the ablation of the ablative layer to pattern the metal film with the smooth nanostructures. The resulting surface finish has a higher optical quality as compared with the surfaces provided by other imprinting processes, such as roll-to-roll printing or lithography. The higher optical quality surface is the side of the film that contacts the mold. Thus, using the laser-induced superplasticity process is advantageous in that the process provides resonance nanostructures with smooth surfaces that are suitable for immediate use in optical systems and photonic-electronic systems without post-processing or additional coatings.

Using the laser-induced superplasticity process is particularly advantageous in forming two-dimensional patterns having different resonance frequencies along the pattern. For example, each resonance element in the formed identification patch may have a different resonance frequency. The pattern may be varied by one of varying the scanning region of the forming laser, varying the forming laser pulse energy over each element, varying characteristics of the mold, and any combination thereof. Characteristics of the mold that may be varied include shapes, depths, and the arrangement of the nanomolds. The mold may have a complete set of nanomolds, or a gap in which a region of the mold does not contain any nanomolds.

Forming the identification patch using the laser-induced superplasticity process is further advantageous in that only one mold may be used, such that the pattern of resonance elements and the resonance frequencies of the resonance elements may be varied only by changing the scanning region of the forming laser. In contrast, conventional processes would require changing the system being used to form the varying patterns. For example, a conventional roll-to-roll printing process would require changing rollers and a conventional lithography process would require changing the lithographic masks.

Additionally, a low-power laser such as a laser engraving machine or cutting machine may be used for forming. The low-powered laser is able to form the smooth surfaces without requiring any post-processing or coating. The laser-induced superplasticity process may also be performed at room temperature and does not require access to a cleanroom or other specific manufacturing environment. Thus, using laser-induced superplasticity provides an identification patch with a unique optical signature that is difficult to replicate using a more economical process as compared with the previous methods.

According to an aspect of the invention, a counterfeit-proof article is formed using a laser-induced superplasticity process.

According to an aspect of the invention, a counterfeit-proof article has an identification patch formed of an array of resonance elements that each have a sub-array of nanostructures.

According to an aspect of the invention, a counterfeit-proof article is formed by scanning a forming laser over a metallic film arranged on a mold containing a plurality of nanomolds.

According to an aspect of the invention, a pattern of resonance elements is varied by at least one of varying a forming laser scanning region, varying laser pulse energies, varying characteristics of a mold, and any combination thereof.

According to an aspect of the invention, varying characteristics of a mold for laser-induced superplasticity includes varying at least one of a depth of nanomolds arranged in the mold, a shape of the nanomolds, and an arrangement of the nanomolds in the mold.

According to an aspect of the invention, a counterfeit-proof article has a two-dimensional pattern of plasmonic resonance elements that each have different resonance frequencies.

According to an aspect of the invention, a method for producing a counterfeit-proof article includes using a laser-induced superplasticity process to form a two-dimensional pattern of plasmonic resonance elements on a sheet of material, each one of the plasmonic resonance elements being formed of a plurality of nanostructures and configured to produce a distinctive optical response in an electromagnetic spectrum, cutting the sheet to form at least one patch containing a portion of the pattern, and attaching the at least one patch to a surface of the article.

According to an embodiment of any paragraph(s) of this summary, the method includes varying the two-dimensional pattern to have plasmonic resonance elements that each produce a different optical response in the at least one patch.

According to an embodiment of any paragraph(s) of this summary, wherein varying the two-dimensional pattern includes varying a scanning region of a forming laser over the sheet of material.

According to an embodiment of any paragraph(s) of this summary, wherein varying the two-dimensional pattern includes varying a laser pulse energy of a forming laser over the sheet of material.

According to an embodiment of any paragraph(s) of this summary, wherein varying the laser pulse energy of the forming laser includes providing a different laser pulse energy for each mold element in a mold that corresponds to one of the plasmonic resonance elements.

According to an embodiment of any paragraph(s) of this summary, the method includes wherein varying the two-dimensional pattern includes varying at least one characteristic of a mold on which the sheet of material is placed during the laser-induced superplasticity process.

According to an embodiment of any paragraph(s) of this summary, wherein varying the at least one characteristic of the mold includes at least one of varying a depth of nanomolds formed in the mold that correspond to the plurality of nanostructures, varying a shape of the nanomolds, and varying an arrangement of the nanomolds on the mold.

According to an embodiment of any paragraph(s) of this summary, wherein varying the arrangement of the nanomolds includes forming a gap in a region containing the nanomolds.

According to an embodiment of any paragraph(s) of this summary, wherein varying the arrangement of the nanomolds includes varying a spacing between the nanomolds.

According to an embodiment of any paragraph(s) of this summary, the method includes forming the plurality of nanostructures having smooth surfaces.

According to an embodiment of any paragraph(s) of this summary, the method includes forming the plurality of nanostructures having shapes that are ridges, teeth, pillars, or posts.

According to an embodiment of any paragraph(s) of this summary, the method includes forming the plurality of nanostructures having shapes that are rectangular, cubic, hemi-spherical, or disc.

According to an embodiment of any paragraph(s) of this summary, the method includes forming the identification patch as a barcode or a hologram.

According to an embodiment of any paragraph(s) of this summary, the method includes forming the two-dimensional pattern on the sheet of material includes patterning a metallic film.

According to an embodiment of any paragraph(s) of this summary, wherein patterning the metallic film includes using a metallic film formed of gold, aluminum, copper, silver, or combinations thereof.

According to an embodiment of any paragraph(s) of this summary, wherein the laser-induced superplasticity process includes placing the metallic film over a mold containing a plurality of nanomolds that correspond to the plurality of nanostructures, using a confinement layer to press the metallic film into the mold, forming an ablative layer of an ablative material on the metallic film under the confinement layer, and scanning a forming laser over the confinement layer.

According to an embodiment of any paragraph(s) of this summary, wherein attaching the at least one patch to the surface of the article includes attaching the patch to an integrated circuit.

According to another aspect of the invention, a counterfeit-proof article includes an exterior surface, and at least one identification patch of material attached to the exterior surface, the identification patch of material having a two-dimensional pattern of plasmonic resonance elements formed on a metallic film, each one of the plasmonic resonance elements being formed of a plurality of nanostructures and configured to produce a distinctive optical response in an electromagnetic spectrum.

According to an embodiment of any paragraph(s) of this summary, the plurality of nanostructures have sizes that are 10 nanometers or greater.

According to still another aspect of the invention, a method of authenticating an article includes attaching a patch having a pattern of plasmonic resonance elements to a surface of the article, the plasmonic resonance elements being formed by a laser-induced superplasticity process and each having a different optical response in an electromagnetic spectrum, irradiating the identification patch using a diagnostic light source having at least one specific wavelength in an ultraviolet, visible, or infrared light region of the electromagnetic spectrum, measuring a resonance absorption spectrum of the plasmonic resonance elements at the at least one specific wavelength, detecting a measured data point on the resonance absorption spectrum, comparing the measured data point to a reference data point corresponding to the resonance absorption spectrum, and verifying the measured data point with the reference data point to authenticate the article.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a flow chart illustrating a method of producing a counterfeit-proof article.

FIG. 2 shows an oblique view of an exemplary counterfeit-proof article.

FIG. 3 shows a side view of a system for producing the counterfeit-proof article of FIG. 2.

FIG. 4 shows a side view of a system for producing the counterfeit-proof article of FIG. 2 according to another exemplary embodiment in which a mold of the system includes a complete set of nanomolds.

FIG. 5 shows a top view of the mold of FIG. 4.

FIG. 6 shows a top view of a scanning region over the mold of FIG. 4 in which a forming laser is scanned over a selective region.

FIG. 7 shows a side view of the system of FIG. 4 during the scanning of the forming laser.

FIG. 8 shows a top view of an identification patch formed by the system of FIG. 4.

FIG. 9 shows a top view of another exemplary scanning method for the mold of FIG. 4 in which the forming laser pulse energy is varied over different regions.

FIG. 10 shows a side view of the system of FIG. 4 when subject to the scanning method of FIG. 9.

FIG. 11 shows a top view of an identification patch formed by the scanning method of FIG. 9.

FIG. 12 shows a side view of a system for producing the counterfeit-proof article of FIG. 2 according to another exemplary embodiment in which the mold includes a complete set of nanomolds having different depths.

FIG. 13 shows a top view of the mold of FIG. 12.

FIG. 14 shows a top view of a scanning region over the mold of FIG. 13.

FIG. 15 shows a side view of the system of FIG. 12 during scanning the forming laser over the mold.

FIG. 16 shows a top view of an identification patch formed by the system shown in FIG. 12.

FIG. 17 shows a top view of a mold according to another exemplary embodiment in which the mold contains an incomplete set of nanomolds.

FIG. 18 shows a top view of an exemplary scanning region over the mold of FIG. 17.

FIG. 19 shows an identification patch formed using the mold and scanning region shown in FIGS. 17 and 18.

FIG. 20 shows a top view of a mold according to another exemplary embodiment in which the mold contains an incomplete set of nanomolds and nanomolds having varying depths.

FIG. 21 shows an identification patch formed using the mold of FIG. 20.

FIG. 22 shows oblique views of exemplary nanostructures that may be formed by the method of FIG. 1.

FIG. 23 shows an exemplary ridge pattern of nanostructures that may be formed by the method of FIG. 1.

FIG. 24 shows another exemplary ridge pattern of nanostructures that may be formed by the method of FIG. 1.

FIG. 25 shows an exemplary fishnet pattern of nanostructures that may be formed by the method of FIG. 1.

FIG. 26 shows an exemplary pillar pattern of nanostructures that may be formed by the method of FIG. 1.

FIG. 27 shows an exemplary system for measuring optical properties of the resonance elements formed by the method of FIG. 1.

FIG. 28 is a flow chart illustrating a method of authenticating the counterfeit-proof article formed by the method of FIG. 1.

### DETAILED DESCRIPTION

The principles described herein have application for authenticating any suitable article in various applications. Examples of suitable articles include manufactured parts or components and paper documents. Examples of paper documents include contracts, checks, passports, birth certificates, driver's licenses, medical forms, paper currency, and any type of legal document or personal identification document. Other suitable articles may include commercial products. In defense applications, various parts or components may require authentication prior to use.

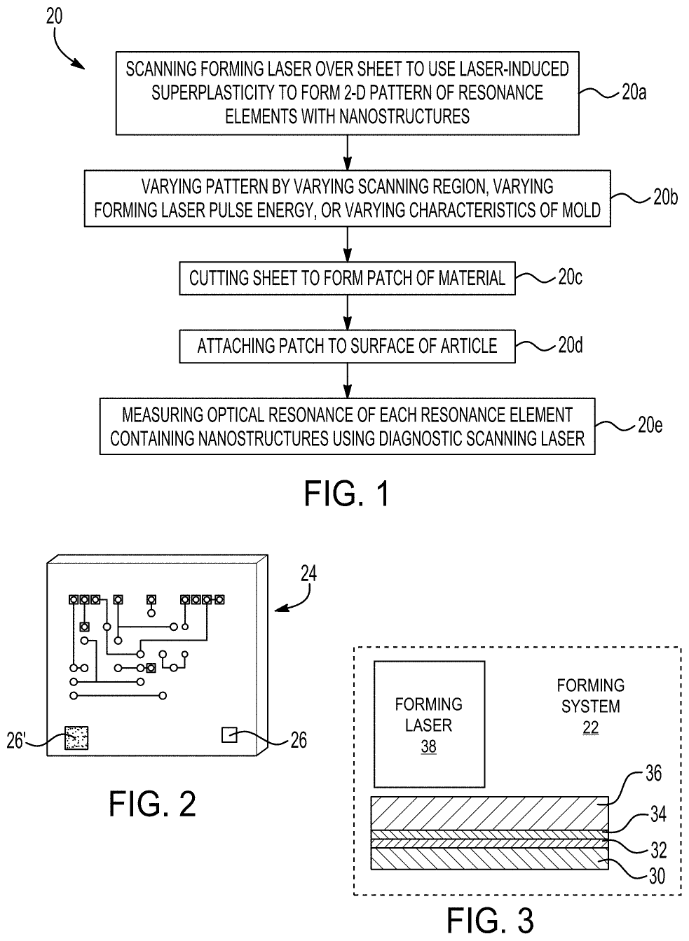

Referring now to FIGS. 1-3, a method 20 and a system 22 for producing a counterfeit-proof article 24 are schematically illustrated. FIG. 1 is a flow chart illustrating the method 20 for producing the counterfeit-proof article 24 and FIG. 2 is a schematic drawing of an exemplary counterfeit-proof article 24 with an identification patch 26. The identification patch 26 includes an array of plasmonic resonance elements which are each formed of a sub-array of nanostructures. Each element within the identification patch 26 may have a unique optical resonance. The counterfeit-proof article 24 may be an integrated circuit, as shown in FIG. 2, but the counterfeit-proof article 24 may be any component, part, module, or suitable article. The counterfeit-proof article 24 may be a metal component. FIG. 3 shows a schematic drawing of an exemplary system 22 used to produce the identification patch 26. The system 22 includes any suitable forming laser that is able to pattern a metallic film to form the identification patch 26 for use in the counterfeit-proof article 24.

The identification patch 26 patch is formed using laser-induced superplasticity of the metallic film such that step 20a of the method 20 includes scanning a forming laser over the metallic film to use laser-induced plasticity in forming a two-dimensional pattern of resonance elements having nanostructures. As shown in FIG. 3, step 20a of the method 20 pertains to using the system 22 which includes a mold 30, a metallic film 32 to be patterned, an ablative coating or layer 34, a confinement layer 36, and a forming laser 38. The mold 30 contains a plurality of nanomolds that may correspond to the formed nanostructures in the resulting identification patch 26. Any suitable material may be used for the mold 30, such as a metal and epoxy. Titanium or other metals may be suitable. In other exemplary embodiments, the mold 30 may be formed of a rubber material.

The metallic film 32 or films may be formed of any suitable metal, such as gold, aluminum, copper, silver, or combinations thereof. Other metallic materials may be suitable. The ablative layer 34 is formed on a side of the metallic film 32 that is opposite to the side of the metallic film 32 that extends over the mold 30. Any suitable ablative material may be used, such as graphite or aluminum. The mold 30 may have any suitable thickness and the metallic film 32 may be relatively thin. For example, the metallic film 32 may have a thickness that is between 1 and 10 microns. The mold 30 has a greater thickness as compared with the metallic film 32, such as a thickness that is between 1 and 10 millimeters.

The confinement layer 36 is pressed against the ablative layer 34 to press the metallic film 32 into the mold 30. A linear actuator or any other suitable control device may be used to exert force against the confinement layer 36. The confinement layer 36 may be formed of a suitable infrared material, such as zinc selenide or calcium fluoride. Any suitable forming laser 38 is then used to irradiate the metallic film 32 on the mold 30. Using the forming laser 38 induces superplastic deformation of the metallic film 32 into the nanoscale features of the mold 30. The superplastic deformation is induced by the shock wave generated by the ablation of the ablative layer 34 and confinement by the confinement layer 36 such that a layer of nanostructures is formed. The peak pressure of the shock wave generated by the forming laser 38 is dependent on the power density of the forming laser 38. Low-power lasers may be suitable for forming, such as lasers having power densities that are less than 5 milliwatts per square centimeter. Lasers having higher power may also be suitable for forming. Laser engravers or cutters may be used to provide the forming laser 38. The propagation of the shock wave along the metallic film 32 induces superplastic strain rates that enable the metallic film 32 to conform to the features of the mold 30.

The metallic film 32 is then patterned with a pattern of ultra-smooth nanostructures. Groups or arrays of the nanostructures form a resonance element that produces a distinctive optical response in an electromagnetic spectrum, and a plurality of resonance elements may be used to form the identification patch 26. Using the laser-induced superplasticity enables a surface finish of the nanostructures that is smooth and has a higher optical quality as compared with using conventional roll-to-roll printing. The formed nanostructures may have minimum feature sizes of 10 nanometers with ultrasmooth surfaces at ambient conditions. The features, such as widths, lengths, depths, or shapes, of each nanostructure, may be varied or ordered to achieve a specific optical response of the corresponding resonance element. The pattern of the nanostructures may also be varied or ordered.

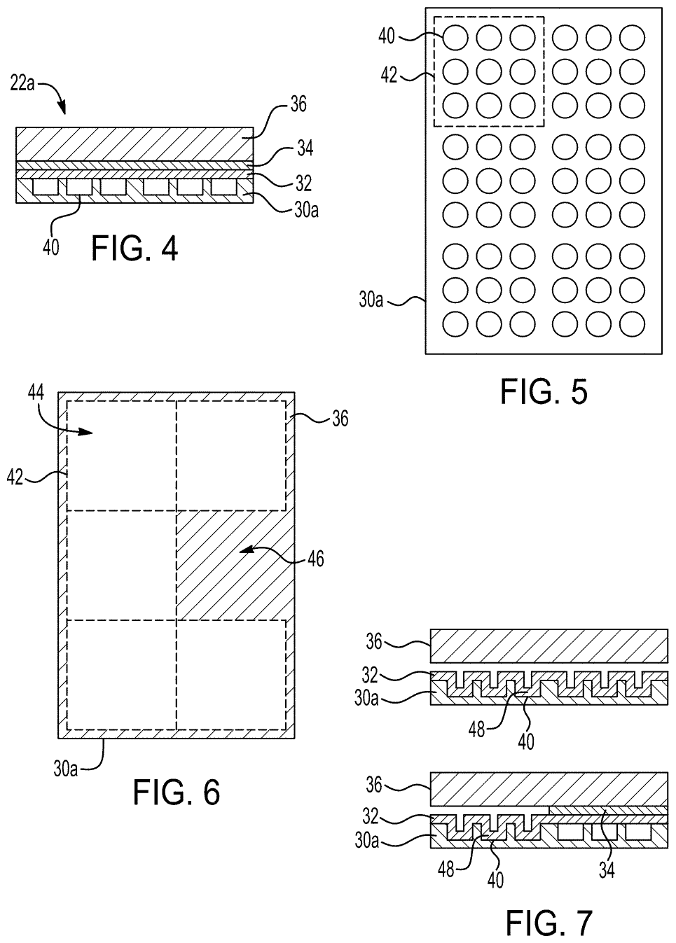

Referring back to FIG. 1 and in addition to FIGS. 4-21, a step 20b of the method 20 includes varying the pattern of nanostructures by at least one of varying the scanning region of the forming laser 38, varying the energy per pulse of the forming laser 38, and varying the characteristics of the mold 30. The characteristics of the mold 30 include the pattern of the nanomolds, the depths of the nanomolds, and the shapes of the nanomolds. Accordingly, many different patterns and resonance frequencies may be achieved by using any combination of varying scanning regions, varying forming laser pulse energies, and varying mold characteristics. FIGS. 4-21 show exemplary methods for forming the identification patch 26 using these different techniques. Any of the methods may be used individually or in combination such that many different patterns are possible for the identification patch 26.

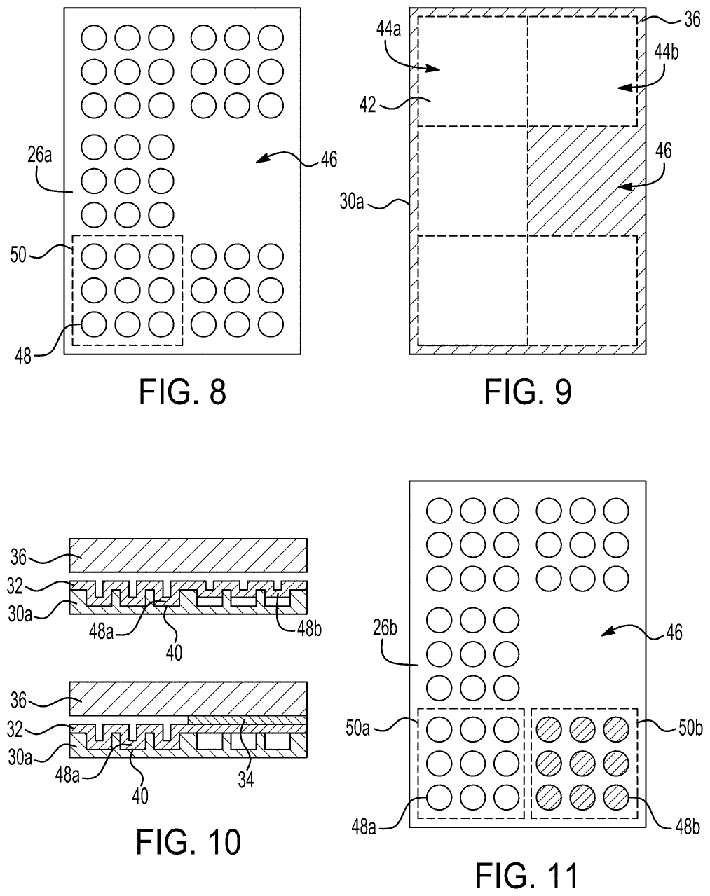

Referring now to FIGS. 4-8, a first method for forming an identification patch 26, such as the identification patch 26a shown in FIG. 8, using the system 22a is shown in which the forming laser scanning region is varied to vary the two-dimensional pattern of nanostructures. The system 22a includes the metallic film 32, the ablative layer 34, the confinement layer 36, and the mold 30a having a pattern of nanomolds 40. Each nanomold 40 corresponds to a nanostructure to be formed. A group or array of the nanomolds 40 corresponds to a mold element 42 which corresponds to a resonance element of the identification patch 26a to be formed. For example, the array of nanomolds 40 may be a three-by-three array, as shown in FIG. 5. A larger or smaller array of the nanomolds 40 and thus formed nanostructures may also be suitable. The formed identification patch 26a includes a group or array of the resonance elements and each resonance element has a distinctive optical response associated with the resonance of the resonance element as determined by the pattern of nanostructures. The resonance element array may be a two-by-three array, as shown in FIG. 5, but a larger or smaller array of the mold elements 42 may also be suitable.

FIG. 4 shows a side view of the mold 30a and FIG. 5 shows a top view of the mold 30a. The nanomolds 40 may be formed to have any suitable shape. The shapes of the nanomolds 40 and thus the formed shape of the nanostructures may be referred to as a dot. Each of the nanomolds 40 may be formed as a cylindrical hole or any other polygonal shape in the mold 30a, such as a rectangle or hexagon. The mold 30a may include a plurality of identical nanomolds 40 that are arranged in an ordered pattern. The shapes of each nanomold 40 may be the same, as shown in FIG. 5, or varied in other exemplary embodiments. The diameters or depths of each nanomold 40 may be the same or varied. The pattern of the nanomolds 40 shown in FIG. 5 is an ordered arrangement including rows and columns of the nanomolds 40, but the pattern may be formed in a disordered arrangement in other exemplary embodiments. The exemplary mold 30a shown in FIG. 5 includes a complete set of identical nanomolds 40 meaning that the entire mold 30a is accommodated by the nanomolds 40. Each nanomold 40 in each mold element 42 is the same in the mold 30a.

FIG. 6 shows selected regions of the mold 30a being scanned by the forming laser 38 over the confinement layer 36 to form the two-dimensional pattern of resonance elements containing the nanostructures. The same laser energy for each pulse may be used to form the pattern of elements that each have the same resonance frequency. The mold 30a includes a scanning region 44 in which the forming laser 38 is scanned over the confinement layer 36. The scanning region 44 may include a plurality of scanning regions that each correspond to one of the mold elements 42. Each scanning region may correspond to a single forming laser pulse and each forming laser pulse may have the same energy for each scanning region. In other exemplary embodiments, the forming laser pulse energies may be varied. FIG. 6 also shows a region 46 in which the forming laser 38 is not scanned over the confinement layer 36 to vary the pattern of the nanostructures in the formed identification patch 26a by providing a gap in the pattern.

The top of FIG. 7 shows the ablative layer 34 under the forming laser pulse being vaporized to form the nanostructures 48 in the metallic film 32. The right side of bottom of FIG. 7 shows the ablative layer 34 that remains in region 46 where the forming laser was not scanned. FIG. 8 shows the resulting pattern of resonance elements 50 containing the nanostructures 48 formed in the identification patch 26a, as formed in an opposing side of the metallic film 32 relative to the side over which the forming laser 38 is scanned. As shown in FIG. 8, the region 46 of the identification patch 26a that was not scanned by the forming laser is not patterned with the nanostructures 48, such that the overall pattern has a gap. For example, the identification patch 26a has five resonance elements 50 that each contain a three-by-three sub-array of the nanostructures 48.

Advantageously, the method shown in FIGS. 4-7 uses one mold, such that the pattern of resonance elements 50 is varied only by changing the scanning region of the forming laser 38. In contrast, conventional processes would require changing the system being used to form the varying patterns. For example, a conventional roll-to-roll printing process would require changing rollers and a conventional lithography process would require changing the lithographic masks.

Referring now to FIGS. 9-11, a second method for forming the identification patch 26b using the system 22a and mold 30a of FIG. 4 is shown in which the two-dimensional pattern of resonance elements and resonance frequency is changed by varying the scan pattern and the forming laser pulse energy. FIG. 9 shows a first scanning region 44a in which the laser pulse of the forming laser 38 has the same energy for each mold element 42 and a second scanning region 44b in which the forming laser 38 has less energy than the energy corresponding to the first scanning region 44a. For example, the first scanning region 44a may correspond to four mold elements 42 of the nanomolds 40 corresponding to the nanostructures and the second scanning region 44b may correspond to one mold element 42 formed of the nanomolds 40. The region 46 corresponds to the region in which the forming laser 38 is not scanned over the confinement layer 36.

FIG. 10 shows the ablative layer 34 under the forming laser pulse being vaporized to form the nanostructures 48 in the metallic film 32 as defined by the mold 30a. FIG. 11 shows the resulting pattern of resonance elements 50a, 50b containing the nanostructures 48a, 48b formed in the identification patch 26b, as formed in an opposing side of the metallic film 32 relative to the side over which the forming laser 38 is scanned. The first resonance element 50a contains the first nanostructures 48a correspond to the first scanning region 44a and the second resonance element 50b contains nanostructures 48b correspond to the second scanning region 44b. The second nanostructures 48b have a lower height in the identification patch 26b as compared with the first nanostructures 48a due to the lower forming laser pulse energy applied over the corresponding nanomolds 40. The region 46 of the identification patch 26b that was not scanned by the forming laser is not patterned with the nanostructures 48 thus forming a gap in the pattern. For example, the identification patch 26b include four first resonance elements 50a and one second resonance element 50b.

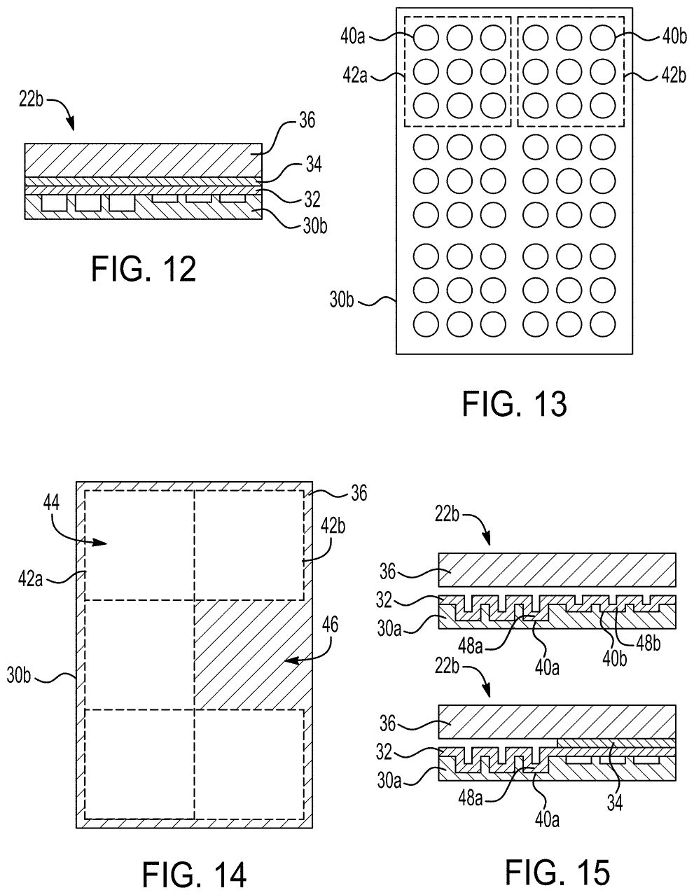

Referring now to FIGS. 12-16, a third method for forming the identification patch 26c using the system 22b is shown in which the two-dimensional pattern is varied by varying characteristics in the mold. The system 22b includes the metallic film 32, the ablative layer 34, the confinement layer 36, and the mold 30b having a pattern of varying nanomolds 40a, 40b. FIG. 12 shows a side view of the mold 30b and FIG. 13 shows a top view of the mold 30b. The nanomolds 40a, 40b have different depths. For example, a second mold element 40b contains the second nanomolds 40b that may have a shallower depth as compared with the depth of the first nanomolds 40a in a first mold element 42a. In other exemplary embodiments, the nanomolds 40a, 40b may have different shapes, with or without varying depths. The resonance frequency for the formed resonance elements 50a, 50b may be determined by the depth of the nanomolds 40a, 40b in the mold elements 42a, 42b.

FIG. 14 shows the scanning region 44 in which the forming laser 38 is scanned over the confinement layer 36 and thus the mold 30b below the confinement layer 36. In the exemplary embodiment of FIG. 14, the same forming laser pulse energy is used for the entire scanning region 44. The region 46 corresponds to the region in which the forming laser 38 is not scanned over the mold 30b. FIG. 15 shows the ablative layer 34 under the forming laser pulse being vaporized to form the nanostructures 48a, 48b in the metallic film 32.

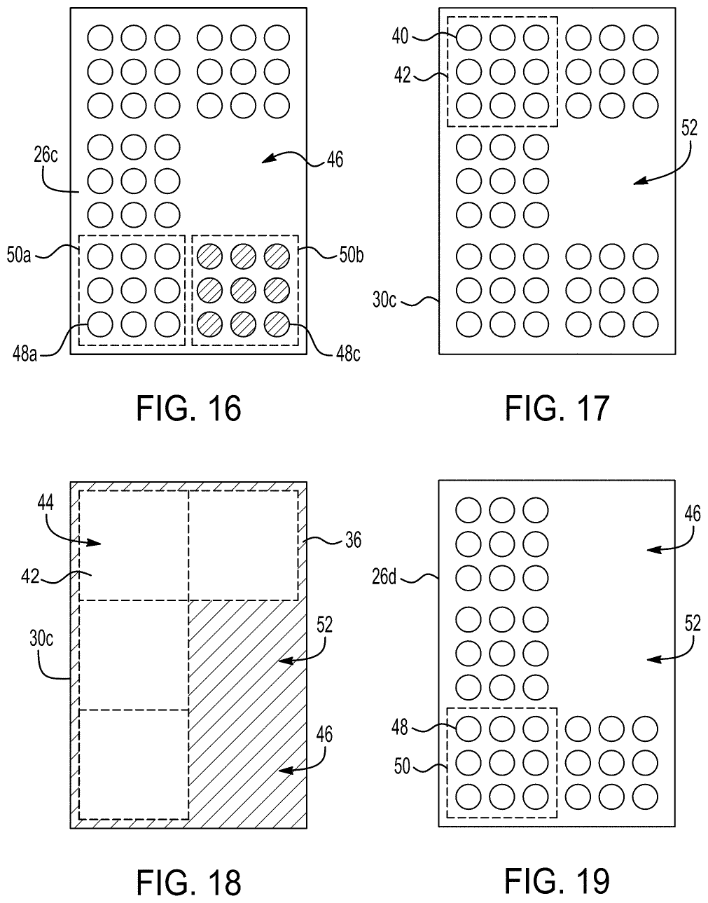

FIG. 16 shows the resulting pattern of nanostructures 48a, 48b formed in the identification patch 26c, as formed in an opposing side of the metallic film 32 relative to the side over which the forming laser 38 is scanned. The identification patch 26c includes the first and second resonance elements 50a, 50b that contain sub-arrays of nanostructures 48a, 48b. The second nanostructures 48c of the second resonance element 50b will have a lower height as compared with the first nanostructures 48a of the first resonance element 50a due to the shallower depth of the second nanomolds 40b as compared with the first nanomolds 40a in the mold 30b. The region 46 that does not contain the nanostructures 48a, 48b corresponds to the region in which the laser 38 was not scanned over the mold 30b.

Referring now to FIGS. 17-19, a fourth method for forming the identification patch 26d using the system 22a of FIG. 4 is shown in which the two-dimensional pattern is varied by the mold 30c having an incomplete set of nanomolds 40. FIG. 17 shows a top view of the mold 30c which includes a region 52 in which nanomolds 40 are not formed. The mold elements 42 containing the nanomolds 40 formed in the other regions of the mold 30c may be identical. FIG. 18 shows the scanning region 44 over the mold elements 42 of the mold 30c and the region 46 in which the forming laser 38 is not scanned over the mold 30c. The forming laser 38 is also not scanned over the region 52 in which the nanomolds 40 are not formed. The forming laser pulse energy is the same along each mold element 42 in the scanning region 44. FIG. 19 shows the resulting pattern of the identification patch 26d which includes the resonance elements 50 containing the sub-array of nanostructures 48 and the regions 46, 52 in which nanostructures 48 are not formed. Accordingly, the identification patch 26d may have a different resonance frequency based on the depth of the mold 30c.

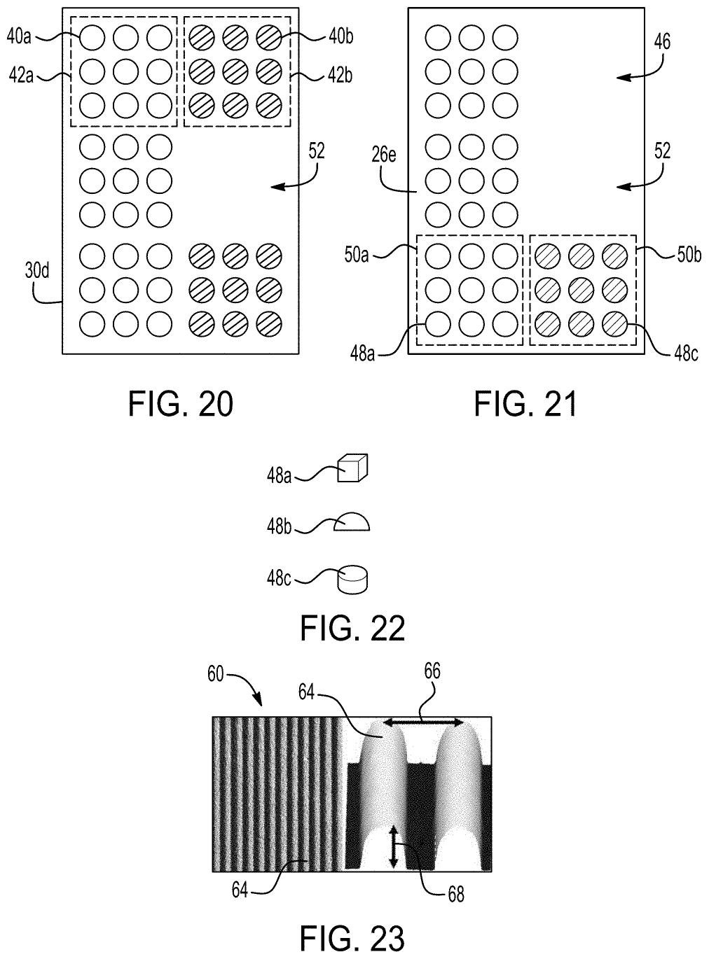

Referring now to FIGS. 20 and 21, a fifth method for forming the identification patch 26e using the system 22a of FIG. 4 is shown in which the two-dimensional pattern is varied by the mold 30c having an incomplete set of nanomolds 40a, 40b with varying depths. FIG. 20 shows a top view of the mold 30d having the first mold elements 42a containing the first nanomolds 40a and the second mold elements 42b containing the second nanomolds 40b that are shallower as compared with the first nanomolds 40a. The mold 30d also include the region 52 in which there is no mold element 42a, 42b containing any nanomolds 40a, 40b.

The forming laser may be scanned over the mold 30d in a region corresponding to the scanning region 44 shown in FIG. 18, with the same laser pulse energy being used along the scanning region 44. FIG. 21 shows the resulting identification patch 26e that includes the first resonance element 50a containing a sub-array of the first nanostructures 48a corresponding to the first nanomolds 40a, and the second resonance element 50b containing a sub-array of the second nanostructures 48c corresponding to the second nanomolds 40b. The second nanostructures 48c have a lower height in the identification patch 26e due to the shallower depth of the second nanomolds 40b as compared with the first nanomolds 40a. The identification patch 26e also includes the regions 46, 52 in which nanostructures 48a, 48c are not formed.

Any of the five methods shown in FIGS. 4-21 may be used in combination to vary the resonance frequency and/or pattern of each resonance element 50 along the identification patch 26 shown in FIG. 2. The laser-induced superplasticity process may be used to form a one-dimensional or two-dimensional barcode 26′, as shown in FIG. 2, that has a varying plasmonic resonance and/or a varying pattern of resonance elements 50. The barcode 26′ is constituted by the identification patch 26 and includes a geometric pattern of the formed nanostructures 48, such as the pattern formed by elements 50a, 50b. Other two-dimensional identifiers may also be formed using the laser-induced superplasticity process. For example, serial numbers, holograms, silk-screened serial numbers, or other patterns may also include the varying plasmonic resonance. Three-dimensional patterns having more dimensions than the two-dimensional patterns may also be formed to have the varying plasmonic resonance.

The laser-induced superplasticity process enables many distinctive patterns of the resonance elements 50 and the nanostructures 48, and empty spaces, such that a particular pattern may be selected to produce a distinctive optical response in a desired portion of the electromagnetic spectrum. The materials and patterns of the identification patch 26, 26′ may be selected to produce an optical response in an ultraviolet, infrared, or visible light region of the electromagnetic spectrum. When the identification patch 26 is irradiated, the identification patch 26 operates by resonating incident flux, causing a field to be built up in the photon absorber layer. The interaction between electromagnetic waves and surface charges of the nanostructures 48 increases momentum of the surface plasmon polariton, deviating from the momentum of incident light through air. When the incident light from the light source and the surface plasmon matches, resonance will occur in the resonance element 50 containing the nanostructures 48.

Referring now to FIGS. 22-26, forming the pattern of the nanostructures 48 may also include equidistantly spacing or varying the spacing between the resonance elements 50 or nanostructures 48 within the resonance elements 50. Ordered patterns or varying patterns may be suitable. The nanostructures 48 may be periodically spaced and shaped to form a pattern that focuses plasma waves into the absorber layer. The pattern of the nanostructures 48 may be varied on a per pixel basis, to provide individualized spectral and/or polarization responses for the pixels of a particular detector array used to measure the optical properties of the resonance elements 50 containing the nanostructures 48. The nanostructures 48 may be arranged to achieve a desired wavelength selectivity or polarization selectivity.

The nanostructures 48 may have any suitable shape and dimensions and may be configured to produce a distinctive optical response for the resonance element 50 in a particular portion of the electromagnetic spectrum. Examples of suitable shapes are protrusions such as pyramidal shaped ridges, pyramidal teeth, circular or rectangular pillars, or circular or rectangular posts. The nanostructures 48 may include additional features located on a top portion of each pillar or post. As shown in FIG. 22, the nanostructures 48 may have a cubic shape 48a, hemi-spherical shape 48b, or cylindrical shape 48c. Hemi-spherical shapes may be advantageous in that the shape enables the structure to easily be released from a mold. Many other suitable shapes may be formed and the shape may be dependent on the material used. The nanostructures 48 may have any suitable dimensions and configurations including patterns with varying spacings between nanostructures 48. Examples of suitable configurations are arrays and gratings.

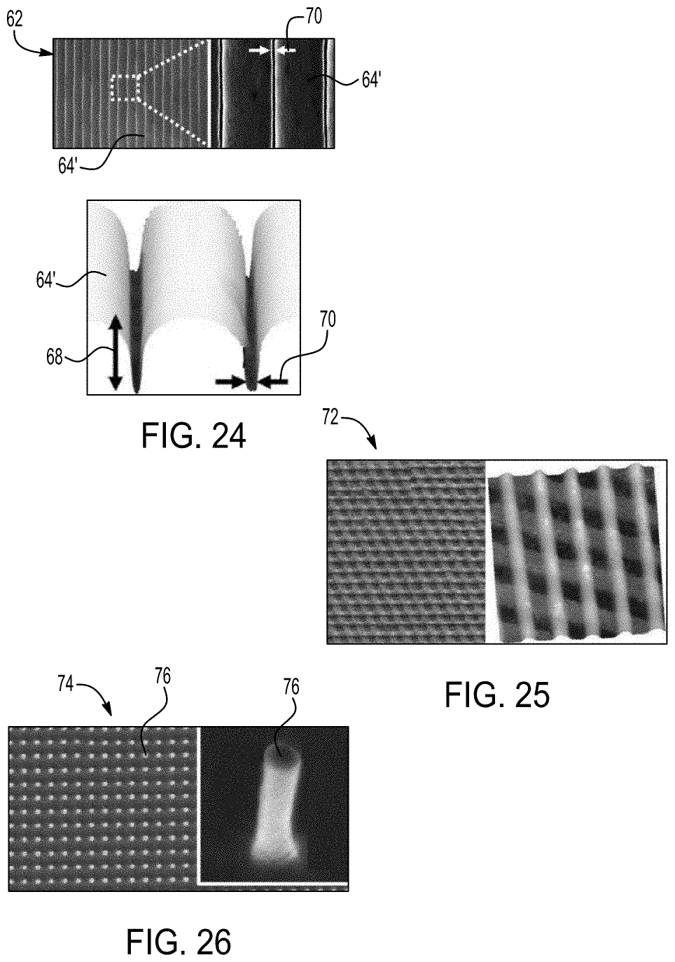

FIGS. 23-26 show exemplary patterns of the nanostructures 48 that may include the shapes shown in FIG. 22. FIGS. 23 and 24 show patterns 60, 62, respectively, including gratings formed of ridges 64, 64′. FIG. 23 shows ridges 64 that are equidistantly spaced with spacings 66 between the centers of the ridges 64 that are between 700 and 800 nanometers. The ridges 64 have heights 68 that are between 100 and 120 nanometers. FIG. 24 shows ridges 64′ having spacings 70 between the edges of the ridges 64′ that are between 35 and 45 nanometers and heights 68 that are between 190 and 210 nanometers. The ridges 64, 64′ are shown as extending a same distance, but the ridges 64, 64′ may also be formed to extend partially with varying lengths. FIG. 25 shows a fishnet pattern 72 and FIG. 26 shows an array pattern 74 of nanopillars 76 having diameters that are between 340 and 360 nanometers and heights that are between 1 and 2 microns. The shapes and patterns shown in FIGS. 23-26 are exemplary and many other shapes and patterns may be formed.

Referring back to FIG. 1, after the metallic film 32 is patterned to form the identification patch 26, such as the identification patches 26a, 26b, 26c, 26d, 26e shown in FIGS. 8, 11, 16, 19, and 21, step 20c of the method 20 for producing the counterfeit-proof article 24 (shown in FIG. 2) may include cutting the patterned metallic film 32 to form the identification patch 26 to be attached to the article 24. The identification patch 26 includes an array of the resonance elements 50 and each array of resonance elements 50 includes a sub-array of the nanostructures 48. The identification patch 26 may have any suitable size and the size of the identification patch 26 may be dependent on the article to which the identification patch 26 is to be attached. The identification patch 26 may have any suitable shape. Examples of suitable shapes include rectangular and circular or disc-shaped. The identification patch 26 may have a length between 1 and 5 millimeters and a width between 1 and 5 millimeters. Step 20c may also include forming a plurality of identification patches that each have a distinctive pattern of the nanostructures 48.

After the identification patch 26 is formed, step 20d of the method 20 includes attaching the identification patch 26 to the article 24 and step 20e includes measuring the optical properties of each resonance element 50 containing the nanostructures 48. The measured data may be stored. Each resonance element 50 may have a distinctive response that is determined by the corresponding nanostructures 48. Measuring the optical properties may include measuring the response of the resonance element 50 to light, such as measuring the resonance absorption. The optical properties of the resonance element 50 may be measured before or after the patterned metallic film 32 is cut to form the at least one identification patch 26. Using techniques as previously described, an array of the resonance elements 50 in the identification patch 26 may have a different resonance frequency for each resonance element 50 such that a unique optical resonance is generated for the identification patch 26.

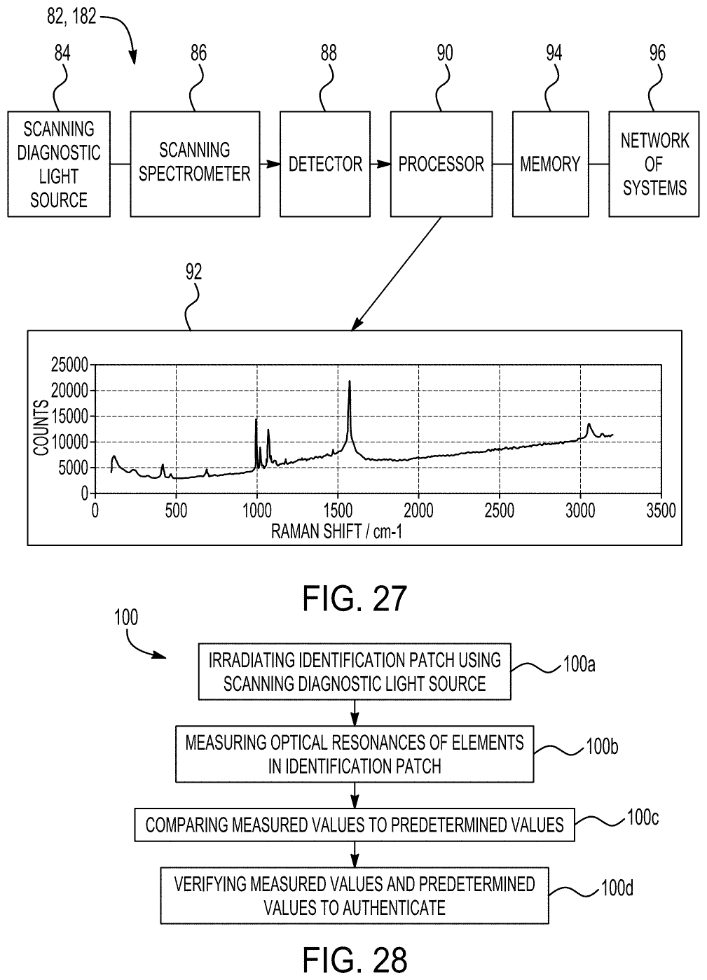

Any suitable system may be used for measuring the optical properties of the identification patch 26 and establishing the data corresponding to the counterfeit-proof article 24. Components of the system may be dependent on the optical property being measured. An exemplary establishment system 82 is schematically shown in FIG. 27. The establishment system 82 may include a scanning diagnostic light source 84 for irradiating the identification patch 26. The scanning diagnostic light source 84 may be any suitable light source for shining light on the identification patch 26 and the form of the scanning light source 84 may be dependent on the materials of the identification patch 26. The diagnostic light source may be dependent on the optical response produced by the identification patch 26. For example, the type of diagnostic light source may be dependent on whether the pattern of nanostructures 48 in the resonance element 50 produces an optical response in an ultraviolet, visible, or infrared light region of the electromagnetic spectrum. The scanning diagnostic light source 84 may be operable at various wavelengths.

The establishment system 82 may include a scanning spectrometer 86 for measuring the optical properties of the resonance elements 50 containing the nanostructures 48. The scanning spectrometer 86 may be configured to measure any suitable optical spectrum, such as the spectrum pertaining to the absorption of the light from the scanning diagnostic light source 84 by the nanostructures 48. When the identification patch 26 is irradiated, the nanostructures 48 may absorb light at predetermined wavelengths of the scanning diagnostic light source 84. Light that is not absorbed is reflected by the nanostructures 48.

The resonance elements 50 containing the nanostructures 48 are formed to have a specific absorption spectrum such that the scanning spectrometer 86 may detect a peak portion of the absorption spectrum to identify a specific wavelength of the absorption spectrum that is preferentially absorbed. The specific wavelength may be used as a reference data point associated with the identification patch 26 since the specific wavelength is unique to the absorption spectrum associated with the pattern of the nanostructures 48. Detecting the peak portion of the absorption spectrum may include detecting a narrowest point of an absorption band to identify the specific wavelength.

After the scanning spectrometer 86 has measured the desired optical spectrum, the establishment system 82 includes a detector 88 that may be part of the scanning spectrometer 86 for converting the measured spectrum into an electrical signal that may be viewed and analyzed using a processor 90. The detector 88 may be configured to receive an analog output from the scanning spectrometer 86 regarding the absorbance spectrum of the pattern of nanostructures 48. As shown in FIG. 27, the processor 90 may be configured to produce an output of data points 92 of the absorbance at different wavelengths of the scanning diagnostic light source 84. The specific data points of the absorption spectrum may be calculated using any suitable algorithm, such as equation (1). Equation (1) is an example of an equation that may be used by the processor 90 to calculate the specific data points of the absorption spectrum.

A(λ)=ε(λ)*l*c (1)

With regards to equation (1), the value A(λ) is the absorption of the pattern of nanostructures 48 calculated as a function of wavelength. The value ε(λ) (L/mol*cm) is the molar absorptivity or extinction coefficient of the absorbing molecule as a function of wavelength. The proportion of the light absorbed may depend on how many molecules interact with the light such that value c (mol/L) is the concentration of the molecules in the irradiated pattern of nanostructures 48. The value l (cm) is the path length traveled by light through the irradiated surface. Equation (2) is another example of an algorithm that may be used by the processor 90 to calculate specific data points of the absorption spectrum.

A=log₁₀(P₀/P) (2)

With regards to equation (2), the value P₀ is the amount of radiant power from a beam of light directed at a surface of the pattern of nanostructures 48 and P is the radiant power of the beam of radiation leaving the surface.

The scanning spectrometer 86, the detector 88, and the processor 90 may be configured to measure any suitable spectral data associated with the resonance element 50 containing the nanostructures 48 and output at least one specific data point associated with the optical resonance of the resonance element 50. As shown in FIG. 27, measuring the absorption of the light may include using Raman spectral data. The scanning spectrometer 86 may be configured to measure Raman scattering, or the inelastic scattering of the photons that strike the molecules of the surfaces of the nanostructures 48. When a molecule takes up energy from or gives up energy to the photons, the photons are scattered with diminished or increased energy, and lower or higher frequency. The frequency shifts are measures of amounts of energy involved in the transition between initial and final states of the scattering molecule. The detector 88 and the processor 90 may be configured to calculate Raman shifts using equation (3) and output the calculated data points, as shown in FIG. 11.

Δw=(1/λ₀−1/λ₁) (3)

With regards to equation (3), the value Δw is the Raman shift in wavenumber, λ₀ is the excitation wavelength and λ₁ is the Raman spectrum wavelength. The Raman spectral data shown in FIG. 27 is associated with an exemplary resonance structure having silver resonance elements, but the Raman spectral data for any resonance structure may be measured.

After the optical properties of the resonance elements 50 containing the nanostructures 48 have been measured by the scanning spectrometer 86 and the detector 88, the processor 90 is also configured to associate a specific data point corresponding to the measured optical properties, such as the absorption spectrum, with the counterfeit-proof article 24. For example, the specific data point may be a wavelength of the scanning diagnostic light source 84 on the absorption spectrum where light is not absorbed by the nanostructures 48. The entire absorption spectrum may also be used as the specific data point, where the absorption spectrum acts as a “fingerprint” or a unique optical signature for the nanostructures 48. The specific data point may be any suitable information that is associated with the particular pattern of the nanostructures 48 of the identification patch 26. The range of wavelengths where the data is measured may be dependent on the size, shape, pattern, and material of the nanostructures 48.

When the specific data point is calculated and determined by the processor 90, the processor 90 may be in communication with a memory 94 including a database for storing the specific data point and/or the entire measured optical spectrum associated with the identification patch 26 and the counterfeit-proof article 24. The specific data point and/or the entire measured optical spectrum serve as identifying information, or a reference data point, for the article 24. The memory 94 may be in communication with a network 96 of processors and systems that are configured to measure optical properties of the identification patch 26. The memory 94 may be accessed at a later point in time when the authenticity of the article 24 is to be verified.

Attaching the identification patch 26 to the article 24 may be performed prior to taking measurements. The identification patch 26 may be attached using any suitable adhesive or fastening mechanism. A surface of the identification patch 26 that is opposite to the surface on which the nanostructures 48 are formed may be configured as the attachment surface. The attachment mechanism may be dependent on the interface between the article 24 and the attachment surface. An example of a suitable adhesive may be an epoxy adhesive. Examples of suitable fastening mechanisms may include threaded fasteners, clamps, and pins.

The method 20 may be repeated to form a plurality of identification patches 26 and attach the plurality of identification patches 26 to the article 24. Each of the plurality of identification patches 26 may have a different absorption wavelength. After at least one identification patch 26 is attached to the article 24, the counterfeit-proof article 24 may be stored for later use or transported from the location where it is produced to another location where it is intended to be used. For example, the counterfeit-proof article 24 may be a part that is produced at a production facility and transferred to another manufacturing facility. When the part is received at the manufacturing facility, the part may be authenticated before being used or implemented in another application. The part may also be stored for a period of time, such that authentication of the part may be desirable before use.

Referring now to FIG. 28, a method 100 of authenticating the counterfeit-proof article 24 is schematically shown in a flowchart. As shown in FIG. 26, the authentication method 100 may include using a counterfeit detecting system 182 for detecting the authenticity of the article. The counterfeit detecting system 182 may be similar to the establishment system 82 used for measuring and establishing the optical properties of the identification patch 26. Step 100a of the authentication method 100 includes irradiating the identification patch using the scanning diagnostic light source 84, as previously described. Step 100b includes measuring optical properties of the resonance elements 50 containing the nanostructures 48 in the identification patch 26. The counterfeit detecting system 182 may include a scanning spectrometer 86, a detector 88, and a processor 90 for measuring the desired optical properties of the resonance elements 50 and determining at least one specific data point associated with the optical properties. As previously described, the specific data point may be a wavelength on the absorption spectrum where light is preferentially absorbed by the nanostructures 48, or the absorption spectrum itself.

After the specific data point is measured and determined, step 100c of the authentication method 100 includes comparing the measured data point to the reference data point that was obtained by the establishment system 82. The processor 90 of the counterfeit detecting system 182 may be configured to compare the data points. More than one data point may be used. For example, the processor 90 may be configured to compare the measured absorption spectrum with the reference absorption spectrum. The processor 90 may be in communication with the memory 94 including the database, as part of the network 96 of processors that are in communication with the database. After comparing the values, step 100d of the authentication method 100 may include verifying the measured data point with the reference data point to authenticate the article 24. The processor 90 may be configured to produce an output indicating whether the article 24 is a counterfeit article. If the article 24 has a plurality of identification patches 26, the authentication method 100 may be repeated for each identification patch 26.

Using laser-induced superplasticity to form a pattern of plasmonic resonance elements containing a plurality of nanostructures on a metallic film is advantageous in producing a plasmonic resonance structure that provides a distinctive optical response in an electromagnetic spectrum. The methods and systems described herein enable a low-cost manufacturing method that does not require providing additional rollers, performing any post-processing, or providing any additional coatings. Using the laser provides a pattern that is harder to counterfeit by enabling varying of the resonance within the pattern of resonance elements. The pattern of resonance elements may be varied by at least one of varying the forming laser scanning region, varying forming laser pulse energies, and varying features of the mold, such as the depths, shapes, or arrangement of nanomolds in the mold.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method for producing a counterfeit-proof article, the method comprising:
using a laser-induced superplasticity process to form a two-dimensional pattern of plasmonic resonance elements on a sheet of material, each one of the plasmonic resonance elements being formed of a plurality of nanostructures and configured to produce a distinctive optical response in an electromagnetic spectrum;
cutting the sheet to form at least one patch containing a portion of the pattern; and
attaching the at least one patch to a surface of the article.

2. The method of claim 1 further comprising varying the two-dimensional pattern to have plasmonic resonance elements that each produce a different optical response in the at least one patch.

3. The method of claim 2, wherein varying the two-dimensional pattern includes varying a scanning region of a forming laser over the sheet of material.

4. The method of claim 2 or 3, wherein varying the two-dimensional pattern includes varying a laser pulse energy of a forming laser over the sheet of material.

5. The method of claim 4, wherein varying the laser pulse energy of the forming laser includes providing a different laser pulse energy for each mold element in a mold that corresponds to one of the plasmonic resonance elements.

6. The method of claim 2, wherein varying the two-dimensional pattern includes varying at least one characteristic of a mold on which the sheet of material is placed during the laser-induced superplasticity process.

7. The method of claim 6, wherein varying the at least one characteristic of the mold includes at least one of:
varying a depth of nanomolds formed in the mold that correspond to the plurality of nanostructures;
varying a shape of the nanomolds; and
varying an arrangement of the nanomolds on the mold.

8. The method of claim 7, wherein varying the arrangement of the nanomolds includes forming a gap in a region containing the nanomolds.

9. The method of claim 6, wherein varying the arrangement of the nanomolds includes varying a spacing between the nanomolds.

10. The method of claim 1 further comprising forming the plurality of nanostructures having smooth surfaces.

11. The method of claim 1 further comprising forming the plurality of nanostructures having shapes that are ridges, teeth, pillars, or posts.

12. The method of claim 1 further comprising forming the plurality of nanostructures having shapes that are rectangular, cubic, hemi-spherical, or disc.

13. The method of claim 1 further comprising forming the identification patch as a barcode or a hologram.

14. The method of claim 1, wherein forming the two-dimensional pattern on the sheet of material includes patterning a metallic film.

15. The method of claim 13, wherein patterning the metallic film includes using a metallic film formed of gold, aluminum, copper, silver, or combinations thereof.

16. The method of claim 14 or 15, wherein the laser-induced superplasticity process includes:
placing the metallic film over a mold containing a plurality of nanomolds that correspond to the plurality of nanostructures;
using a confinement layer to press the metallic film into the mold;
forming an ablative layer of an ablative material on the metallic film under the confinement layer; and
scanning a forming laser over the confinement layer.

17. The method of claim 1, wherein attaching the at least one patch to the surface of the article includes attaching the patch to an integrated circuit.

18. A counterfeit-proof article comprising:
an exterior surface; and
at least one identification patch of material attached to the exterior surface, the identification patch of material having a two-dimensional pattern of plasmonic resonance elements formed on a metallic film, each one of the plasmonic resonance elements being formed of a plurality of nanostructures and configured to produce a distinctive optical response in an electromagnetic spectrum.

19. The counterfeit-proof article according to claim 18, wherein the plurality of nanostructures have sizes that are 10 nanometers or greater.

20. A method of authenticating an article, the method comprising:
attaching a patch having a pattern of plasmonic resonance elements to a surface of the article, the plasmonic resonance elements being formed by a laser-induced superplasticity process and each having a different optical response in an electromagnetic spectrum;
irradiating the identification patch using a diagnostic light source having at least one specific wavelength in an ultraviolet, visible, or infrared light region of the electromagnetic spectrum;
measuring a resonance absorption spectrum of the plasmonic resonance elements at the at least one specific wavelength;
detecting a measured data point on the resonance absorption spectrum;
comparing the measured data point to a reference data point corresponding to the resonance absorption spectrum; and
verifying the measured data point with the reference data point to authenticate the article.
